(19) United States
(12) Patent Application Publication
(10) Pub. No.: US 2010/0216383 A1
(43) Pub. Date: Aug. 26, 2010

(54) Sash operating device for fume hoods

(76) Inventor: Bruce C. Cathcart, Mystic, CT (US)

Correspondence Address: Breiner & Breiner, L.L.C., P.O.Box 320160, Alexandria, VA, 22320-0160, US

(21) Appl. No.: 12/656,958

(22) Filed: Feb. 22, 2010

Related U.S. Application Data
(60) Provisional application No. 61/208,410, filed on Feb. 24, 2009.

(51) Int. Cl. B08B 15/02

(52) U.S. Cl. 454/61

(57) ABSTRACT

The invention is a sash operating device for a fume hood having a moveable sash. The sash operating device automatically closes the sash when a user is not near the sash for a predetermined period of time. The device may be manually controlled by the user to open, close or vary the size of the sash opening. The sash operating device has a drive wheel which contacts the sash with a normal force such that the device can open and close the sash.

### RELATED APPLICATION

This application hereby claims the benefit under 35 U.S.C. §119(e) of U.S. Provisional Application Ser. No. 61/208,410, filed Feb. 24, 2009, entitled “AUTOMATIC SASH CLOSING DEVICE FOR FUME HOODS”.

### FIELD OF INVENTION

The present invention relates to a sash operating device for a fume hood having a movable sash. The sash operating device will automatically close the sash when a user is not near the fume hood for a predetermined period of time. Additionally, the sash operating device may be manually controlled by the user to open, close or vary the size of the sash opening.

### BACKGROUND OF INVENTION

Fume hoods have been used in laboratories for many years to protect users from exposure to harmful chemicals, biologicals and other substances. The basic operation of a fume hood provides a flow of air admitted into the fume hood to be exhausted away from a user by an exhaust blower. Generally, a front of the fume hood has a movable sash which is typically fitted in the fume hood, is made of glass or other transparent material so that the contents of the fume hood can be viewed when the sash is closed, and can be opened to a desired height to provide the user with access to the fume hood and the contents therein.

Although fume hoods have proven to be effective, fume hoods require a substantial flow of room air. This requires energy to either heat the air in the winter or cool the air in the summer. Therefore, energy costs associated with fume hoods can be substantial, especially in a laboratory having numerous fume hoods.

Others have recognized the substantial energy costs associated with fume hoods and have tried to design devices that mitigate these costs by closing the sash of the fume hood when the user is not present. For example, some of these devices can detect the presence of the user by an automatic switch coupled to a floor mat or an electric eye. However, these devices can, for example, be complex, difficult to assemble, difficult to use and/or expensive.

For example, (1) U.S. Pat. No. 4,150,606 is said to disclose an automatic fume hood sash operator for opening and closing a fume hood sash which consists of an electric motor and a pulley which drives a cable connected to counterweights attached to the sash; (2) U.S. Pat. No. 4,502,375 is said to disclose a fume hood sash operator including a motor, a belt drive, pulleys and a clutch mechanism; and (3) U.S. Pat. No. 4,774,878 is said to disclose a fume hood sash operator utilizing a fluid power system having a pressure fluid cylinder.

Although these and other devices are capable of moving the sash, the devices have shortcomings, including that the devices are complex, expensive to manufacture and difficult to install. Additionally, certain devices require additional utilities, such as compressed gas or another power source, which further adds to the expense and complicates the installation thereof. Accordingly, there is a need for a sash operating device which is, among other things, easy and cost effective to manufacture, install and operate, and does not require extensive disassembly of the fume hood to install. This need and the shortcomings of known devices are addressed by the present invention.

### SUMMARY OF INVENTION

The present invention is a sash operating device for a fume hood having a movable sash. The sash operating device will automatically close the sash when the sash is open and a user is not near the fume hood for a predetermined period of time. The sash operating device has a drive wheel which contacts and engages the sash with a normal force to open and close the sash.

A primary object of the invention is to provide a compact and self-contained sash operating device that is easy to operate and easy to install on a fume hood adjacent to the sash. The sash operating device mounts to the fume hood without having to disassemble the fume hood or without requiring access to internal mechanical components of the fume hood for installation.

Another primary object of the invention is to provide a sash operating device which automatically closes the sash when the user is not present. Additionally, the device may be manually controlled to open and close the sash or to vary the size of the sash opening.

Another primary object of the invention is to provide a sash operating device that is easily disengaged from the sash by a user manually overriding the device by pulling the device away from the sash so that the drive wheel no longer contacts the sash. Disengagement of the device may be needed at various times such as in the case of an emergency, power failure, moving equipment into or out of the fume hood, where the user desires to have the fume hood remain open, or so the sash operating device can be used on a different fume hood.

Another object of the invention is to provide a sash operating device which provides a safety feature such that if a user or an object interferes with the sash, the force exerted on the sash by the sash operating device is limited by the normal force between the drive wheel and the sash. This prevents the user from being hurt or the object from being damaged by the sash.

Another object of the invention is to provide a sash operating device that can be used on sashes that open vertically or horizontally.

The sash operating device comprises a housing, a drive wheel, a motion sensor, a mounting assembly, an optical sensor and additional electronic components. The housing encloses the components of the device. The drive wheel contacts and engages the sash with a normal force, or optionally with other closing means, to enable the device to open and close the sash. The motion sensor detects when a user is not near the fume hood so that the device can automatically close the sash. The mounting assembly mounts the sash operating device to the fume hood adjacent to the sash so that the drive wheel contacts the sash and provides the normal force. The optical sensor detects the position of the sash. The other electronic components of the device aid in the operation of the device.

These and other objects of the invention will be apparent from the following description of the preferred embodiments of the invention and the accompanying drawings.

### BRIEF DESCRIPTION OF THE DRAWINGS

Referring to the drawings:

FIG. 1 is a perspective view of a fume hood with a sash operating device of the present invention mounted thereto;

FIG. 2 is a perspective view of the sash operating device of FIG. 1;

FIG. 3 is another perspective view of the sash operating device of FIG. 1;

FIG. 4 is a perspective view of the inside of the sash operating device of FIG. 1;

FIG. 5 is another perspective view of the inside of the sash operating device of FIG. 1;

FIGS. 6 and 7 are alternative embodiments of a drive wheel of the sash operating device; and

FIG. 8 is a partial cross-sectional view of the sash operating device of FIG. 1 mounted to a fume hood illustrating the drive wheel in contact with the sash.

### DETAILED DESCRIPTION OF THE PREFERRED EMBODIMENTS

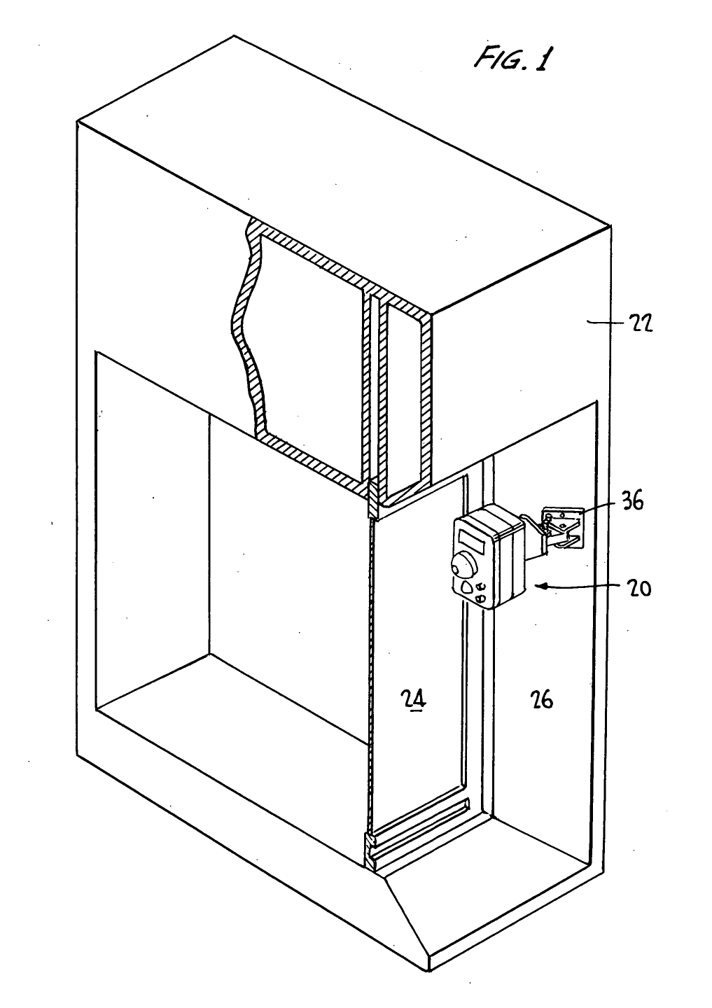

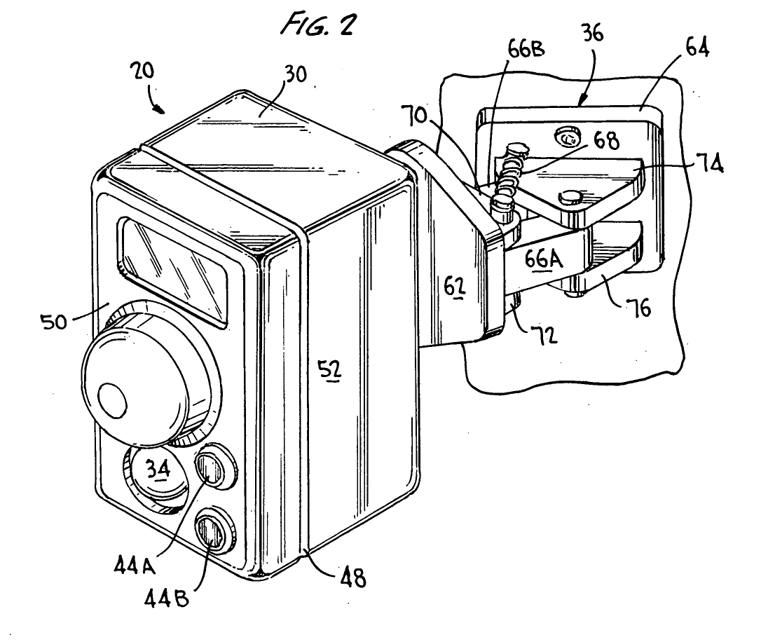

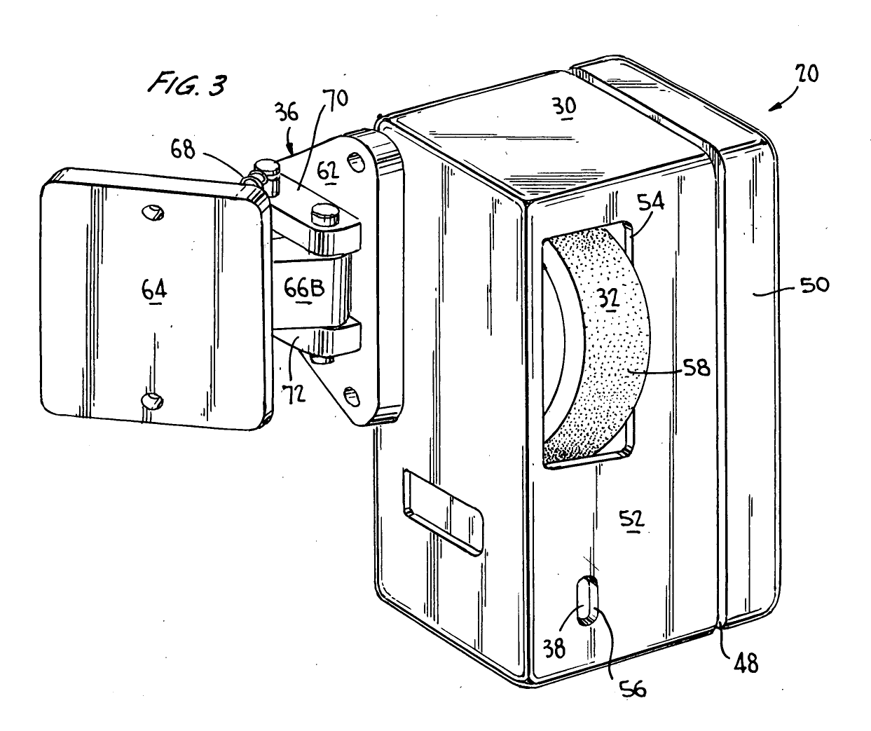

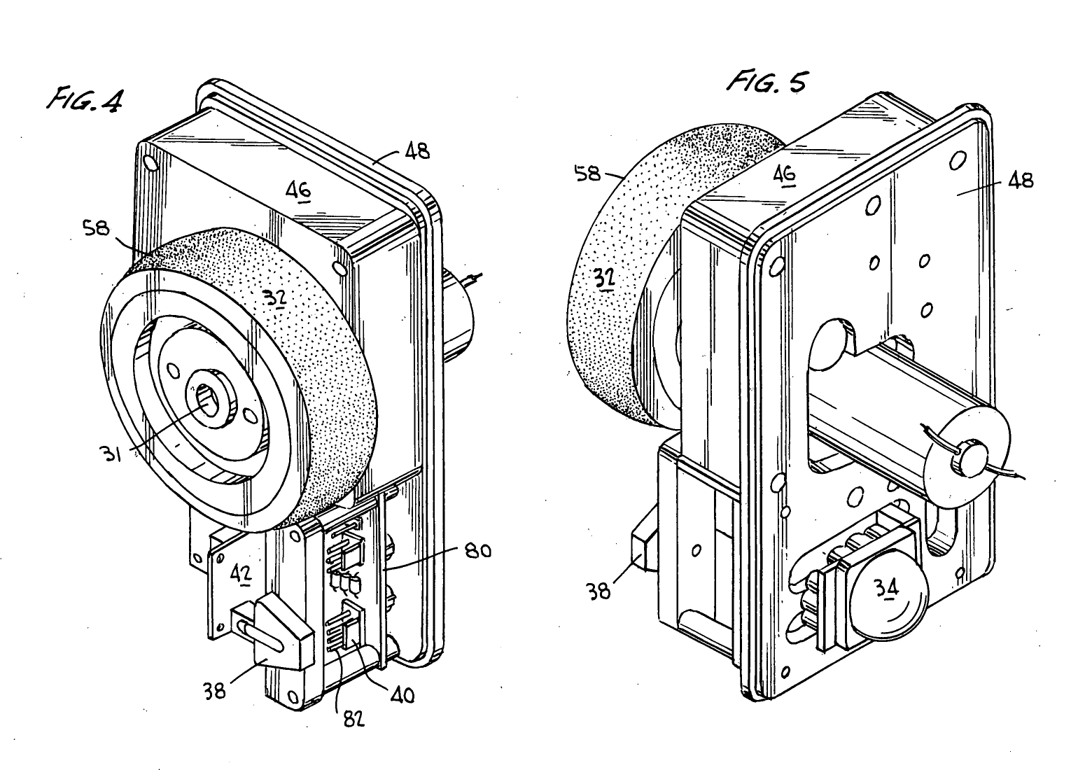

Referring to FIGS. 1-8, the present invention is a sash operating device 20 for a fume hood 22 having a movable sash 24. The sash operating device 20 may be mounted to a wall 26 of fume hood 22. The sash operating device 20 will automatically close the sash 24 when a user is not present. Such closure will occur after a predetermined period of time which may be set by the device manufacturer and/or programmed by the user. Additionally, the user may manually control the sash operating device 20 to open, close or vary the sash opening as desired. Further, the user may easily disengage the sash operating device 20 from sash 24 and then later re-engage sash operating device 20.

As shown, for example, in FIG. 1, the sash operating device 20 mounts on wall 26 of fume hood 22 by a mounting assembly. The sash operating device 20 contacts and engages sash 24 with a normal force therebetween. Generally, the normal force is the force of a surface acting on an object which is perpendicular to the plane of contact therebetween. For example, the normal force is the force of sash operating device 20 acting on sash 24.

Sash operating device 20 comprises housing 30; drive wheel 32; motion sensor 34; mounting assembly 36; optical sensor 38; and additional electronic components for operating device 20. These additional electronic components include circuitry 40; microcontroller 42; control members 44A, 44B; and motor 46. The device 20 may also include a mounting plate 48 for securing the various components inside housing 30.

Housing 30 encloses the components of the sash operating device 20. Housing 30 is preferably made of a plastic, a metal or a combination thereof and is rectangular, although other shapes and embodiments may be used. Housing 30 includes front cover 50 and base 52 which attach to mounting plate 48 by a pressure fit. In the alternative, fastening members such as screws may be used. Drive wheel 32 is rotatably mounted in housing 30 on shaft 31 which is driven and rotated in a predetermined direction by motor 46. Drive wheel 32 extends through opening 54 of housing 30.

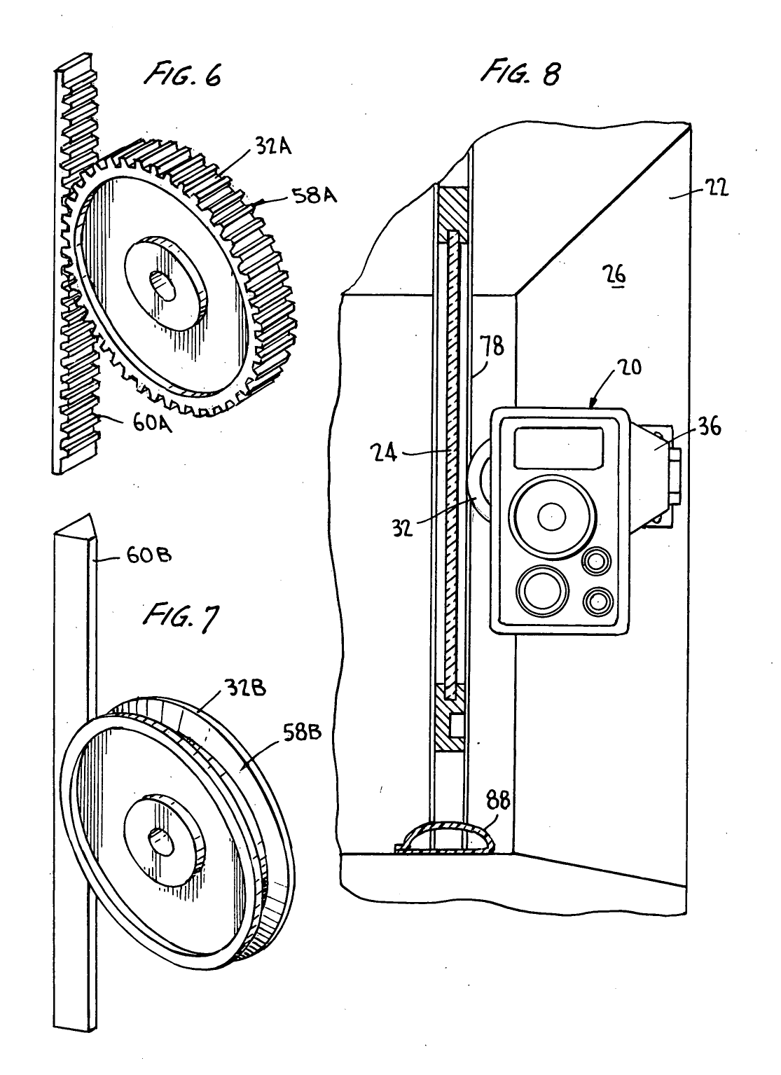

The outer surface 58 of drive wheel 32 is substantially smooth and contacts and engages sash 24 with the normal force to open and close the sash 24. In the alternative, drive wheel 32 may have other configurations such as shown, for example, in FIGS. 6 and 7. In FIG. 6, the drive wheel comprises a timing pulley assembly wherein the drive wheel 32A has a toothed outer surface 58A which corresponds to a toothed strip 60A positioned on sash 24. The teeth 58A engage strip 60A such that drive wheel 32A moves along strip 60A, thereby opening and closing the sash 24. In FIG. 7, the drive wheel comprises a V-groove pulley system having a drive wheel 32B with a grooved outer surface 58B which corresponds to a strip 60B having a protrusion along a length thereof. The groove 58B engages the protrusion such that drive wheel 32B moves along strip 60B, thereby opening and closing sash 24.

Motion sensor 34 is adjacent an opening in housing 30 and detects whether the user is near fume hood 22. When sash 24 is open and motion sensor 34 detects that the user is not near fume hood 22, drive wheel 32 automatically rotates to close sash 24. More particularly, motion sensor 34 sends a signal to microcontroller 42 which processes the signal along with a signal from optical sensor 38 which indicates that sash 24 is not closed and after a predetermined period of time sends a further signal to motor 46 to rotate shaft 31 and drive wheel 32 to close sash 24.

Mounting assembly 36 mounts sash operating device 20 to wall 26 adjacent to sash 24 such that drive wheel 32 contacts sash 24 with the normal force. Particularly, sash operating device 20 is mounted on wall 26 near the non-opening end of sash 24, i.e., near the top of sash 24 for vertically opening sashes. Mounting assembly 36 includes a first plate being a device mounting plate 62, a second plate being a fume hood mounting plate 64, linkage arms 66A, 66B connecting device mounting plate 62 to fume hood mounting plate 64, and a spring 68 between device mounting plate 62 and fume hood mounting plate 64. Spring 68 provides tension to mounting assembly 36 to enable drive wheel 32 to contact sash 24 with the normal force. Device mounting plate 62 attaches to base 52 and fume hood mounting plate 64 attaches to fume hood 22.

More particularly, device mounting plate 62 and fume hood mounting plate 64 are connected by a hinge assembly comprising hinge plates 70 and 72 on device mounting plate 62 and hinge plates 74 and 76 on fume hood mounting plate 64 which are connected via linkage arms 66A and 66B. Spring 68 attaches to or between device mounting plate 62 and fume hood mounting plate 64 and provides tension in the mounting assembly 36 such that sash operating device 20, via drive wheel 32, contacts sash 24 with the normal force. This normal force can be varied by changing the stiffness of spring 68 or by adding one or more springs to mounting assembly 36. Mounting assembly 36 also maintains the orientation of sash operating device 20 while device 20 moves toward or away from sash 24.

Optical sensor 38 is located inside of sash operating device 20 adjacent to drive wheel 32. Optical sensor 38 is aligned with an optical indicator 78 located on sash 24. Optical sensor 38 detects the presence, absence or change in the optical indicator. Optical sensor 38 then sends a corresponding signal to microcontroller 42 which determines whether sash 24 is open or closed.

The optical indicator in the presently preferred embodiment is reflective label 78 located on an edge of sash 24 adjacent to sash operating device 20 and corresponding to the direction that sash 24 moves. When sash 24 opens vertically, reflective label 78 is positioned vertically along a side of sash 24 and optical sensor 38 is aligned with reflective label 78. More particularly, reflective label 78 may be an elongated strip having a first color in a first predetermined area and a second color in a second predetermined area. For example, the first color is white and is located in all places on reflective label 78 that are adjacent to optical sensor 38 when sash 24 is open. The second color is black and is located on reflective label that is adjacent to optical sensor 38 when sash 24 is closed.

Optical sensor 38 detects the color of reflective label 78, and sends a signal to microcontroller 42 which processes the signal to determine whether sash 24 is open or closed. The reflective label may also be used to increase friction between drive wheel 32 and sash 24.

Alternatively, the optical indicator may only be present on sash 24 in areas adjacent to optical sensor 38 when sash 24 is closed. Optical sensor 38 then detects the optical indicator and sends a signal to microcontroller 42 which registers that sash 24 is closed. When optical sensor 38 does not detect the optical indicator, optical sensor 38 sends a signal to microcontroller 42 which registers that sash 24 is open. In another alternate embodiment, the optical indicator may only be placed on sash 24 in areas adjacent to optical sensor 38 when sash 24 is open.

Alternatively, the optical indicator on sash 24 may be a color indicator, a light indicator, a pattern indicator, a marking indicator or the like.

In an alternative embodiment, the optical sensor may be replaced by a mechanical member, magnetic member or inductive sensor to detect the presence, absence or change in a predetermined indicator positioned on sash 24 to determine the position thereof.

The additional electronic components of the sash operating device 20 enable control and operation of device 20 and include circuitry 40; microcontroller 42; control members 44A and 44B; and motor 46.

Circuitry 40 includes circuit board 80 with connectors 82 which attach to wires. Circuitry 40 attaches microcontroller 42 to the other components of the device including at least motion sensor 34, optical sensor 38 and control members 44A and 44B so that microcontroller 42 can receive and process signals therefrom. Microcontroller 42 also sends signals to motor 46 to rotate shaft 31 and drive wheel 32.

Control members 44A and 44B enable the user to manually control device 20 to open and close sash 24. More particularly, control member 44A is a switch which when pushed causes the drive wheel to rotate to open sash 24 and control member 44B is a switch which when pushed causes the drive wheel to rotate to close sash 24. Alternatively, the control member may include at least one of a single switch, button, knob, dial or the like to control device 20.

Motor 46 rotates shaft 31 and drive wheel 32 thereon. Motor 46 is preferably a standard gear motor, but may be any other suitable type of motor.

To automatically close sash 24, optical sensor 38 and motion sensor 34 send respective signals to microcontroller 42 which processes these signals to determine the position of sash 24 and whether the user is near fume hood 22. When microcontroller 42 determines that sash 24 is open and the user is not present, and a predetermined period of time has elapsed, microcontroller 42 sends a signal to motor 46 causing motor 46 to rotate shaft 31 and drive wheel 32. To close sash 24, drive wheel 32 rotates in a direction such that the portion of drive wheel 32 contacting sash 24 moves in a downward direction. The normal force therebetween contributes to a frictional force between sash 24 and drive wheel 32, causing sash 24 to close. Drive wheel 32 rotates until optical sensor 38 detects the presence, absence or change of the optical indicator on sash 24, and sends a signal to microcontroller 42 which sends a signal to motor 46 to stop rotating drive wheel 32. Alternatively, sash 24 may be manually closed by control member 44B.

When microcontroller 42 determines that sash 24 is open and the user is present, sash 24 remains open until microcontroller 42 determines that the user is not present and closes sash 24.

To open sash 24, control member 44A is pushed and drive wheel 32 rotates in a direction such that the portion of drive wheel 32 contacting sash 24 moves in an upward direction. The normal force between rotating drive wheel 32 and sash 24 contributes to the frictional force therebetween, causing sash 24 to open.

If the user desires to disengage sash operating device 20 from sash 24, the user can manually override sash operating device 20 by pulling the sash operating device 20 away from sash 24, so that drive wheel 32 no longer contacts sash 24. For example, the user may disengage sash operating device 20 in the event of a power failure, if the sash needs to remain open to load or unload equipment from the fume hood, if the user does not want sash 24 to automatically close, or if sash 24 needs to be closed immediately such as in an emergency.

Sash operating device 20 is preferably supplied with electrical power for operation thereof by a power adapter (not shown) and can be plugged into a standard electrical outlet (not shown). Alternatively, sash operating device 20 may use batteries or another power source.

As shown for example in FIG. 8, a sill guard 88 may be positioned directly under sash 24 on fume hood 22. Sill guard 88 is made of a flexible elastomeric extrusion material and has a convex surface facing sash 24. The convex shape of sill guard 88 prevents an object from sitting flat on the floor of fume hood 22 and reminds the user not to place items beneath sash 24 while open. Sill guard 88 collapses when sash 24 contacts sill guard 88, allowing sash 24 to close.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A sash operating device for automatically controlling opening and/or closing of a movable sash of a fume hood, the sash operating device comprising:
(a) a housing including
(i) a rotatable drive wheel constructed and arranged to contact the movable sash;
(ii) a motion sensor constructed and arranged to detect whether a user is present near the fume hood; and
(iii) a member constructed and arranged to detect a position of the movable sash; and
(b) a mounting member constructed and arranged to mount the sash operating device to the fume hood, wherein the mounting member is constructed and arranged to provide a normal force between the drive wheel and the movable sash.

2. The sash operating device of claim 1, wherein the drive wheel has an outer surface which is substantially smooth, toothed or grooved.

3. The sash operating device of claim 1, further comprising a control member for manually opening or closing the movable sash.

4. The sash operating device of claim 1, wherein the member constructed and arranged to detect the position of the movable sash is an optical sensor which is constructed and arranged to detect a presence of an optical indicator operatively positioned on the movable sash.

5. The sash operating device of claim 4, wherein the optical indicator comprises an elongated strip having at least one of a color indicator, a light indicator, a pattern indicator, or a marking indicator.

6. The sash operating device of claim 4, wherein the optical indicator comprises a reflective label having a first color in a first predetermined area which is adjacent to the optical sensor when the movable sash is open and a second color in a second predetermined area which is adjacent to the optical sensor when the movable sash is closed.

7. The sash operating device of claim 1, wherein the mounting member comprises:
a first mounting plate operatively attached to the housing;
a second mounting plate constructed and arranged to attach to the fume hood;
at least one linkage arm attached to the first mounting plate and the second mounting plate; and
at least one spring constructed and arranged to provide tension to the mounting member.

8. A sash operating device for controlling opening and/or closing of a movable sash of a fume hood, the sash operating device comprising:
(a) a housing including a rotatable drive wheel constructed and arranged to contact the movable sash; and
(b) a mounting member constructed and arranged to mount the sash operating device to the fume hood, wherein the mounting member is constructed and arranged to provide a normal force between the drive wheel and the movable sash.

9. The sash operating device of claim 8, further comprising an optical sensor constructed and arranged to detect a position of the movable sash.

10. The sash operating device of claim 9, further comprising a motion sensor constructed and arranged to detect whether a user is present near the fume hood.

11. The sash operating device of claim 10, further comprising a motor having a rotatable shaft extending therefrom, wherein the drive wheel is operatively positioned on the rotatable shaft and rotated by the motor.

12. The sash operating device of claim 11, further comprising a microcontroller having circuitry and connecting wires which connect the microcontroller to at least the motor, the motion sensor, and the optical sensor, wherein the microcontroller receives and processes at least one signal from at least one of the motion sensor, and/or the optical sensor, and then sends a corresponding signal to the motor to rotate the drive wheel in a predetermined direction.

13. The sash operating device of claim 12, further comprising a control member for manually opening or closing the movable sash.

14. The sash operating device of claim 13, wherein the mounting member comprises:
a first mounting plate operatively attached to the housing;
a second mounting plate constructed and arranged to attach to the fume hood;
at least two linkage arms substantially parallel to each other, the two linkage arms attached to the first mounting plate and the second mounting plate; and
at least one spring operatively positioned between the first mounting plate and the second mounting plate.

15. The sash operating device of claim 8, wherein the drive wheel has an outer surface which is substantially smooth, toothed or grooved.

16. A method of controlling opening and/or closing of a movable sash of a fume hood with the sash operating device of claim 1, comprising:
mounting the sash operating device to a wall of the fume hood adjacent to the movable sash;
positioning the sash operating device such that the drive wheel contacts the movable sash with the normal force;
positioning the sash operating device such that the member which is constructed and arranged to detect the position of the movable sash is aligned with an optical indicator operatively positioned on or adjacent to the movable sash; and
controlling a direction of rotation of the drive wheel to open or close the movable sash.

17. A method of controlling opening and closing of a movable sash of a fume hood with the sash operating device of claim 8, comprising:
mounting the sash operating device to a wall of the fume hood adjacent to the movable sash;
positioning the sash operating device such that the drive wheel contacts the movable sash with the normal force; and
controlling a direction of rotation of the drive wheel to open or close the movable sash.

18. A sash operating kit for controlling opening and/or closing of a movable sash of a fume hood, the sash operating kit comprising:
(a) a sash operating device for opening, closing, or opening and closing the movable sash; and
(b) an optical indicator constructed and arranged for application to the movable sash.

19. The sash operating kit of claim 18, further comprising a sill guard to be operatively positioned under the movable sash.

20. The sash operating kit of claim 19, wherein the sill guard has a convex surface.
